(19) United States
(12) Patent Application Publication
(10) Pub. No.: US 2005/0066453 A1
(43) Pub. Date: Mar. 31, 2005

(54) Photochromic dye

(76) Inventors: Jen-Yi Chiu, Zhonghe City (TW); Chung-Hsin Wu, Zhonghe City (TW); Chong-Yu Chen, Zhonghe City (TW); Chong-Guang Zhuo, Zhonghe City (TW); Zong-Tai Hong, Zhonghe City (TW); Shih-Chieh Lin, Zhonghe City (TW); Xin-Heng Liu, Zhonghe City (TW); Han-Bin Gao, Zhonghe City (TW); Zhi-Ming Xu, Zhonghe City (TW); Jia-Xian Hg, Zhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/910,292

(22) Filed: Aug. 4, 2004

(30) Foreign Application Priority Data
Sep. 29, 2003 (TW) 092126772

(51) Int. Cl. C09B 67/00

(52) U.S. Cl. 8/635

(57) ABSTRACT

The invention provides a photochromic dye of a structure containing a common structure of spirooxazine series compounds and three substituents. The photochromic dye according to the invention exhibits characteristics of a high heat stability, good light fatigue resistance, high sensitivity, extremely degradation rate and the like. This photochromic dye can be formulated with suitable organic solvents and used as photochromic functional colorants under UV light excitation. Further, this photochromic dye can be synthesized and purified in simple steps with cheap raw materials and hence at a greatly lowered production cost.

### FIELD OF THE INVENTION

The invention relates to a photochromic dyes, and in particular to a photochromic dyes characterized in that it can change into a different color upon being excited by ultraviolet light.

### BACKGROUND OF THE INVENTION

Photochromic dyes belong to a kind of organic photochromic dyes. Photochromic functional colorant refers to a pigment with special functional properties. In contrast to the conventional pigment that emphasizes only on the function of pigmentation, the pigment property of a photochromic functional dye will has its color phase changed with its outer environment, such as, for example, light, heat, electricity, solvents, pressure and pH. For the industry at present, only a small amount of photochromic dye will bring about instantly the desired color changing effect, and hence is a product of high added value and high applicability. Accordingly, most of chemists today are developing novel organic photochromic dyes in order to take advantage of more intensive applications of organic photochromic dyes.

The principle of seeing depends on the reflection or absorption of visible light by a material, that is, when the material is irradiated by light, it will absorb a portion of the incident light and reflect or refract the remaindering light into eyes such that different colors of the material can be seen. As a result, if, for example, light transmits completely through a material, the material will neither absorb nor reflect light and hence is seen to be colorless, i.e., its can not be seen by eyes. On the other hand, if the incident light is completely reflected by the material and hence presents as white, while it is black by absorbing light completely. In general, the material can have a variety of color when it absorbs or reflects only part of visible light. Therefore, the color of a material depends on not only the property and structure of the molecule itself, but also the property of light irradiated on the material.

The visible light has a wavelength in a range of from 400 nm to 800 nm, and has a relationship of its wavelength with respect to color as shown in FIG. 1. Therefore, the color thus seen is the color exhibited from the remaindering wavelength after a material absorbing a certain part of the visible light, i.e., the basic color of a material is the complementary color of its maximum absorption wavelength. By way of example, if a material has its maximum absorption wavelength λmax=588 nm, its means that this material absorbs yellow light and hence exhibits a blue color.

Among an organic photochromic dye, the one that is most well known and has more extensive application is the photochromic dye, or known as photochromic functional colorants. The photochromic phenomenon is described earliest in the scientific literature in 1876 by E. ter Meer who found that the color of the potassium salt of dinitromethane changed under sunlight irradiation. Subsequently, W. Marckwald observed in 1899 that the color of the crystal of 1,4-dihydro-2,3,4,4-tetrachloronaphthalen-1-one changed from colorless to purple upon sunlight irradiation, while restored to its original color when the crystal was placed in dark. This light-induced color change was referred then by W. Marckwald as “photropy”. Until 1950, Y. Hirshberg suggested this light-induced color change a term as “photochromism” with a definition as “the visible light absorption spectrum of a substance will be changed considerably and reversibly as it is exposed under activating radiation, while can be restored to its original state through an opposite color change mechanism by heating, placing in dark or being irradiated by light having different wavelength”.

Since photochromic substance had been discovered in 1876, it has been developed more than hundred years. Little study had been done before 1920. More researches appeared since 1940, but were restricted to the investigation on strange chemical phenomena. Until 1956, Y. Hirshberg proposed first the application of photochromic compounds on an optical memory. Since then, many international research organizations devoted successively in this field and as a result, hundreds types of photochromic functional colorants, and particularly, even more types of organic photochromic compounds, had been developed up to date. Among these substances, 5 series are known as follow:

1. Azobenzene Series

As shown in FIG. 2, pigments of azobenzene series demonstrate their photochromism through cis-tans summarization. Photochromism of azobenzene series photochromic pigment takes place when trans azobenzene series pigments is irradiated under ultraviolet light, whereby their structure will transform from the more stable trans form into the liable cis form. Because the cis form has higher energy and is more liable, it can restore easily to the original trans form under visible light or heating conditions and consequently, heat extinction is occurred. Recently, Z. F. Liu et al. had studied the possibility of transforming cis-azobenzene into more stable trans-azobenzene in order to apply on optical memory.

2. Salicylidene Aniline Series

Salicylidene aniline series photochromic pigments, as shown in FIG. 3, were discovered by M. D. Cohen in 1962. As salicylidene aniline series photochromic pigment is irradiated by ultraviolet light, the hydrogen ion of —OH on the enol-form will be excited and transferred on a nitrogen atom to form a keto-form having a colored state. M. D. Cohen had shown that the requisite for the photochromism exhibited by this type of pigment is the presence of a —OH group on the ortho position of the Schiff's Base. If, on the other hand, the —OH group is present on para position, absence of being substituted with other group (for example, a methoxy group), the photochromism exhibited by this type of pigment will disappear. On the other hand, K. S. Sharma had study the photochromic principle of salicylidene anilines and found that the photochromism is resulted from hydrogen transfer due to cis-trans summarization during the rotation of C═N bond. This type of photochromic pigment has good photolytic property but lack of heat stability.

3. Fulgide Series

Fulgide series, as shown in FIG. 4, was found by H. Stobbe in 1904, and was developed further by H. G. Heller for its application for the storage and reading on optical memory. Its photochromism relies on the cyclisation of the structure of the fulgide photochromic pigment occurred upon irradiation with light of a specific wavelength and thereby producing color. Although the heat resistance and light fatigue resistance of this type of photochromic pigment are better than those of spiropyran, there are many problems to be solved, such as, for example, optical sensitivity and the like.

4. Spiropyran Series

Spiropyran series, as shown in FIG. 5, had been studied with respect to its photochromism first by E. Fischer in 1952. Since the applicability of spiropyrans on optical memory being proposed by Y. Hirshberg in 1956, studies on the spiropyrans photochromic material has constituted the majority of studies on photochromic materials. Results from these studies revealed that there must be a nitro-substituent present on the benzopyran ring for a compound of the spiropyran series to produce photochromism effectively. Reasons therefore comprise: 1. The nitro group can introduce a triplet-pathway to increase the quantum-yield of photocoloration; 2. The nitro group can stabilize the amphoteric ion merocyanine at its photocolorated state such that the reverse reactivity of heat extinction can be lowered. The incorporation of the nitro group, however, is not favorable for the photochemical stability of spiropyran, that is, its light fastness will be lowered.

5. Spirooxazine Series

Spirooxazine series photochromic pigment, as shown in FIG. 6, was discovered first by R. E. Fox in 1961. The structure of spirooxazine series photochromic pigment is similar with that of spiropyran series photochromic pigment, except that the C═C bond on the pyran ring of spiropyran is replaced with a C═N bond to form spirooxazines. The photochromism exhibited by spirooxazine series photochromic pigment is also very analogous to that by spiropyran series photochromic pigment, namely, under irradiation with ultraviolet light, the bond between the spiro carbon and the adjacent oxygen atom will take place non-uniform cleavage and form a conjugated state to become a colored merocyanine. Later studies by Nori Y. C. Chu, Susumu Kawauchi confirmed that, among existing photochromic pigments at present, spirooxazine series exhibit the best light fatigue resistance.

Each of the five series of photochromic materials described above has respective advantages and disadvantages. Nevertheless, following conditions must be satisfied with respect to their application for storage on information medium:
1. High heat stability: After irradiating the photochromic pigment with light of specific wavelength, the chemical state thus formed must exhibit good heat stability in a dark place, and the information should be stored over a long period without damage.
2. Good light fatigue resistance: The writing and erase of information can be repeated up to thousands times.
3. High sensitivity: The storage and erase of information should be done rapidly under irradiation with light of specific wavelength.
4. Extremely small damage rate: During the reading and resolving of the information recorded by the photochromic pigment, the degree of damage of the pigment should be extremely low.

Although the possibility of photochromic pigments for applying on optical memory was proposed as early as in 1956 by Y. Hirshberg, this applicability of photochromic material in the storage on an optical memory has never been practiced heretofore for following reasons:
1. Most of the photochromic pigments had poor heat stability.
2. They might be degraded or denatured after use or storage for a long period.

Spirooxazine series pigment is well known as the one exhibiting the best light fatigue resistance amount photochromic pigments. This type of pigment has the best light fatigue resistance among the well-known photochromic pigments.

In order to overcome the problem of degradation due to repeated use or long-term storage occurred in the early application of photochromic pigment on optical memory, the inventor had devoted to improve and innovate, and, after carrying out intensive study for many years, had accomplished successfully the photochromic functional colorants according to the invention that has lower cost, is simpler to synthesis and more suitable to apply on optical memory.

### SUMMARY OF THE INVENTION

The primary object of the invention is to provide a photochromic functional colorants characterized in that it exhibits high heat stability, good light fatigue resistance and high sensitivity.

The secondary object of the invention is to provide a photochromic functional colorant characterized in that it can be prepared by simple synthetic and purification steps with cheap materials and greatly lowered cost.

Another object of the invention is to provide a photochromic functional colorant characterized in that it has higher absorption coefficient to ultraviolet light, greater solubility in organic solvent and easy to application.

The photochromic functional colorant that can realize objects described above is the photochromic functional colorant with a chemical formula shown in FIG. 7.

In the formula shown in FIG. 7, R1 and R2 is independently selected from the group consisting of a linear or branched alkyl containing 1 to 20 carbon atoms, a linear or branched alkenyl containing 2 to 20 carbon atoms, a linear or branched alkynyl containing 2 to 20 carbon atoms, a linear or branched alkoxy containing 1 to 20 carbon atoms, a haloalkyl, haloalkenyl, a halogen atom- or hydrogen atom-containing functional groups; R3 may be a secondary amino group with a linear, cyclic or branched functional group containing 1 to 10 carbon atoms attached on its secondary nitrogen atom. The photochromic functional colorant according to the invention can be formulated with a suitable organic solvent and can change its color upon excited by ultraviolet light.

### BRIEF DESCRIPTION OF THE DRAWING

The present invention may best be understood through the following description with reference to the accompanying drawings, in which:

FIG. 1 is a graph showing the relationship of the absorption wavelength and the color.

FIG. 2 shows the general structure of the azobenzene series pigment.

FIG. 3 shows the general structure of the salicylidene aniline series pigment.

FIG. 4 shows the general structure of the fulgide series pigment.

FIG. 5 shows the general structure of the spiropyran series pigment.

FIG. 6 shows the general structure of the spirooxazine series pigment.

FIG. 7 shows the chemical structure of the spirooxazine dye according to the invention.

FIG. 8 illustrates the synthesis of Fisher base (c)°

FIG. 9 illustrates the synthesis of spirooxarines dye (e).

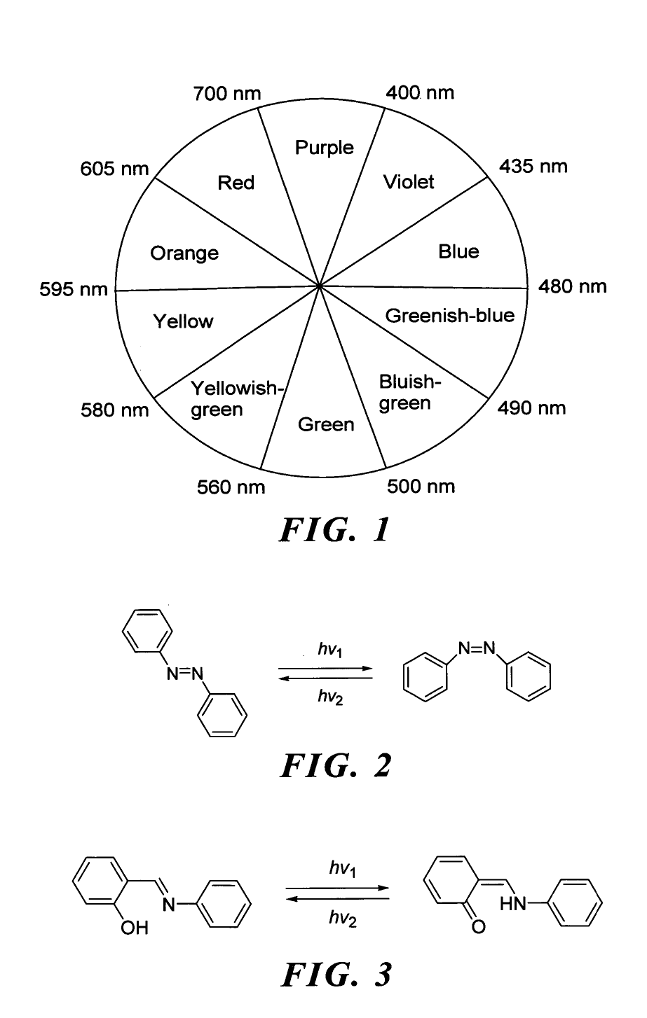

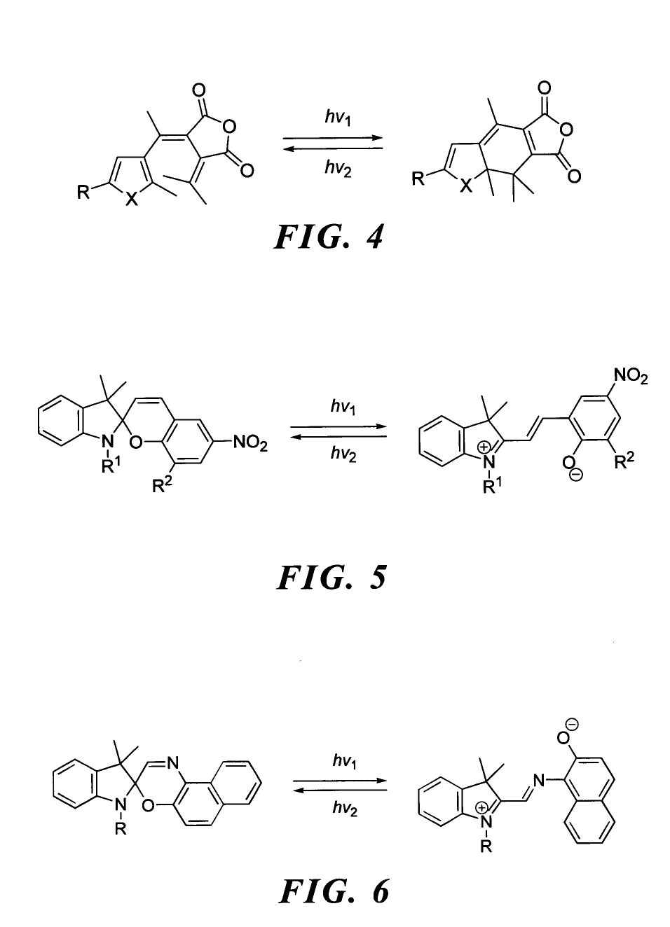

### DETAILED DESCRIPTION OF THE PREFERRED EMBODIMENTS

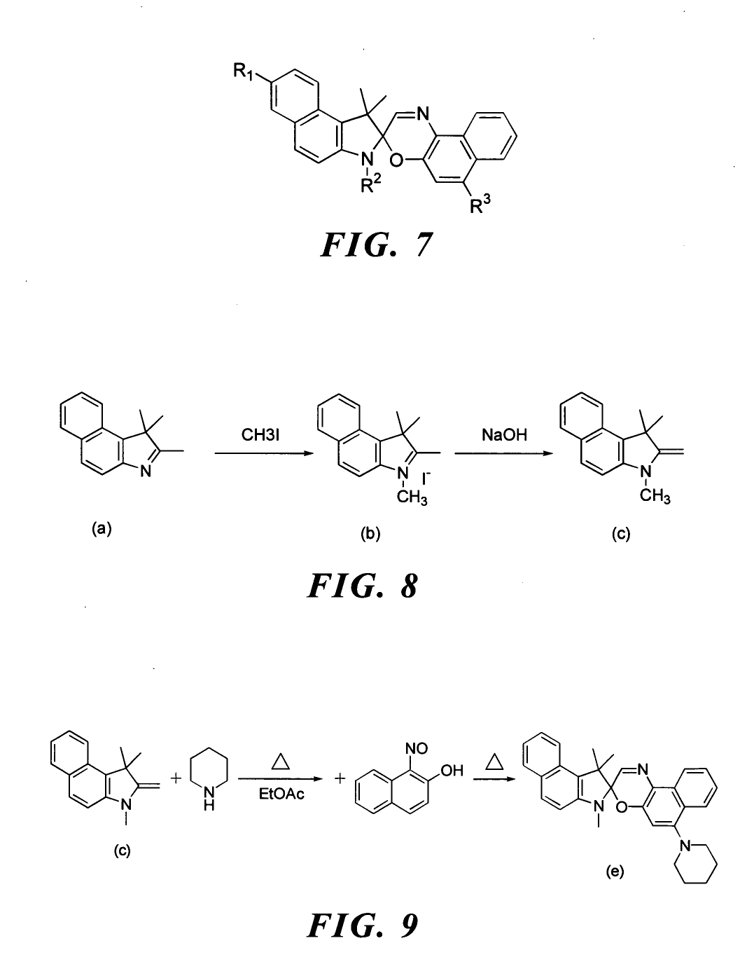

The technical disclosure of the invention will be now illustrated in conjunction with the accompanied drawings as follow. As stated above, the invention provides a dye that can be used in the recording layer of a high-density recordable optical disk. This dye has a chemical structure as shown in FIG. 7.

In the formula shown in FIG. 7, R1 and R2 is independently a linear or branched alkyl containing 1 to 20 carbon atom, such as, for example, methyl, ethyl, propyl, isopropyl, butyl, isobutyl, neobutyl, pentyl, isopentyl, neopentyl, hexyl, isohexyl, neohexyl, cyclohexyl, heptyl, octyl, nonyl, decyl, 2-methylbutyl, 3-methylbutyl, 2-methylpentyl, 3-methylpentyl, 4-methylpentyl, 2,3-dimethylbutyl, 2-ethylhexyl, 3-methylhexyl, 4-methylhexyl, 5-methylhexyl, 2,4-dimethylpentyl, 2-methyl-5-butylhexyl, 2,5-dimethylhexyl, 6-methylheptyl, 2-methylheptyl, 2,2-dimethylheptyl, 4-methylheptyl, 5-methylheptyl, 3,5-dimethylheptyl, 2,5-dimethylheptyl, 2,4-dimethylheptyl; a linear or branched alkenyl containing 2 to 20 carbon atom, such as, for example, ethenyl, propenyl, butenyl, isobutenyl, pentenyl, isopentenyl, hexenyl, isohexenyl, cyclohexenyl, heptenyl, octenyl, nonenyl, decenyl, 2-methylbutenyl, 3-methylbutenyl, 2-methylpentenyl, 3-methylpentenyl, 4-methylpentenyl, 2,3-dimethylbutenyl, 2-ethylhexenyl, 3-methylhexenyl, 4-methylhexenyl, 5-methylhexenyl, 2,4-dimethylhexenyl, 2-methyl-5-butylhexenyl, 2,5-dimethylhexenyl, 6-methylheptenyl, 2-methylheptenyl, 2,2-dimethylheptenyl, 4-methylheptenyl, 5-methylheptenyl, 3,5-dimethylheptenyl, 2,5-dimethylheptenyl, 2,4dimethylheptenyl, 2,5-dimethyl-5-hexenyl, 2,5-dimethyl-1-hexenyl; a linear or branched alkynyl containing 2 to 20 carbon atom, such as, for example, ethynyl, propynyl, butynyl, pentynyl, hexynyl, isohexynyl, cyclohexynyl, heptynyl, octynyl, nonynyl, decynyl, 3-methylbutynyl, 3-methylpentynyl, 4-methylpentynyl; or a linear or branched alkoxy containing 1 to 20 carbon atom, such as, for example, methyl ethyl ether, methyl propyl ether, methyl isopropyl ether, methyl butyl ether, methyl isobutyl ether, methyl pentyl ether, methyl isopentyl ether, ethyl ethyl ether, ethyl propyl ether, ethyl isopropyl ether, ethyl butyl ether, ethyl isobutyl ether, ethyl pentyl ether, ethyl isopentyl ether, propyl ethyl ether, propyl propyl ether, propyl isopropyl ether, propyl butyl ether, propyl isobutyl ether, propyl pentyl ether, propyl isopentyl ether; haloalkyl, such as, for example, chloromethyl, dichloromethyl, trichloromethyl, 1-chloroethyl, 1,2-dichloroethyl, 1,1,2,2-tetrachloroethyl, 1-chloropropyl, 2-chloropropyl, 1,2-dichloropropyl, 1,1,2,2-tetrachloropropyl, 1-chlorobutyl, 2-chlorobutyl, 1,2-dichlorobutyl, 1,1,2,2-tetrachlorobutyl, 1-chloropentyl, 2-chloropentyl, 1,2-dichloropentyl, 1,1,2,2-tetrachloropentyl, 1-chlorohexyl, 2-chlorohexyl, 1,2-dichlorohexyl, 1,1,2,2-tetrachlorohexyl, 1-chlorocyclohexyl, 2-chlorocyclohexyl, 1,2-dichlorocyclohexyl, 1,1,2,2-tetrachlorocyclohexyl, 1-chlorocyclohexyl, 2-chlorocyclohexyl, 1,2-dichlorocyclohexyl, 1,1,2,2-tetrachlorocyclohexyl, bromomethyl, dibromomethyl, tribromomethyl, 1-bromoethyl, 1,2-dibromoethyl, 1,1,2,2-tetrabromoethyl, 1-bromopropyl, 2-bromopropyl, 1,2-dibromopropyl, 1,1,2,2-tetrabromopropyl, 1-bromobutyl, 2-bromobutyl, 1,2-dibromobutyl, 1,1,2,2-tetrabromobutyl, 1-bromopentyl, 2-bromopentyl, 1,2-dibromopentyl, 1,1,2,2-tetrabromopentyl, 1-bromohexyl, 2-bromohexyl, 1,2-dibromohexyl, 1,1,2,2-tetrabromohexyl, 1-bromocyclohexyl, 2-bromocyclopentyl, 1,2-dibromocyclopentenyl, 1,1,2,2-tetrabromocyclopentenyl, 1-bromocyclohexyl, 2-bromocyclohexyl, 1,2-dibromocyclohexyl, 1,1,2,2-tetrabromocyclohexyl, iodomethyl, diiodomethyl, triiodomethyl, 1-iodoethyl, 1,2-diiodoethyl, 1,1,2,2-tetraopdpethyl, 1-iodopropyl, 2-iodopropyl, 1,2-diiodopropyl, 1,1,2,2-tetraiodopropyl, 1-iodobutyl, 2-iodobutyl, 1,2-diiodobutyl, 1,1,2,2-tetraiodobutyl, 1-iodopentyl, 2-iodopentyl, 1,2-diiodopentyl, 1,1,2,2-tetraiodopentyl, 1-iodohexyl, 2-iodohexyl, 1,2-diiodohexyl, 1,1,2,2-tetraiodohexyl, 1-iodocyclopentyl, 2-iodocyclopentyl, 1,2-diiodocyclopentyl, 1,1,2,2-tetraiodocyclopentyl, 1-iodocyclohexyl, 2-iodocyclohexyl, 1,2-diiosocyclohexyl, 1,1,2,2-tetraiodocyclohexyl, fluoromethyl, difluoromethyl, trifluoromethyl, 1-fluoroethyl, 1,2-difluoroethyl, 1-fluoropropyl, 2-fluoropropyl, 1,2-difluoropropyl, 1-fluorobutyl, 2-fluorobutyl, 1,2-difluorobutyl, 1-fluoropentyl, 2-fluoropentyl, 1,2-difluoropentyl, 1-fluorohexyl, 2-fluorohexyl, 1,2-difluorohexyl, 1-fluorocyclopentyl, 2-fluorocyclopentyl, 1,2-difluorocyclopentyl, 1-fluorocyclohexyl, 2-fluorocyclohexyl, 1,2-difluorocyclohexyl; haloakenyl, such as, for example, 1-chloroethenyl, 1,2-dichloroethenyl, 1,1,2,2-tetrachloroethenyl, 1-chloropropenyl, 2-chloropropenyl, 1,2-dichloropropenyl, 1,1,2,2-tetrachloropropenyl, 1-chlorobutenyl, 2-chlorobutenyl, 1,2-dichlorobutenyl, 1,1,2,2-tetrachlorobutenyl, 1-chloropentenyl, 2-chloropentenyl, 1,2-dichloropentenyl, 1,1,2,2-tetrachloropentenyl, 1-chlorohexenyl, 2-chlorohexenyl, 1,2-dichlorohexenyl, 1,1,2,2-tetrachlorohexenyl, 1-bromoethenyl, 1,2-dibromoethenyl, 1,1,2,2-tetrabromoethenyl, 1-bromopropenyl, 2-bromopropenyl, 1,2-dibromopropenyl, 1,1,2,2-tetrabromopropenyl, 1-bromobutenyl, 2-bromobutenyl, 1,2-dibromobutenyl, 1,1,2,2-tetrabromobutenyl, 1-bromopentenyl, 2-bromopentenyl, 1,2-dibromopentenyl, 1,1,2,2-tetrabromopentenyl, 1-bromohexenyl, 2-bromohexenyl, 1,2-dibromohexenyl, 1,1,2,2-tetrabromohexenyl, 1-iodoethenyl, 1,2-diiodoethenyl, 1,1,2,2-tetraiodoethenyl, 1-iodopropenyl, 2-iodopropenyl, 1,2-diiodopropenyl, 1,1,2,2-tetraiodopropenyl, 1-iodobutenyl, 2-iodobutenyl, 1,2-diiodobutenyl, 1,1,2,2-tetraiodobutenyl, 1-iodopentenyl, 2-iodopentenyl, 1,2-diiodopentenyl, 1,1,2,2-tetraiodopentenyl, 1-iodohexenyl, 2-iodohexenyl, 1,2-diiodohexenyl, 1,1,2,2-tetraiodohexenyl; halogen, such as, for example, fluoro, chloro, bromo, or iodo; or hydrogen; wherein R3 may be a secondary amino group substituted on its nitrogen atom with a linear, cyclic or branched alkyl containing 1 to 20 carbon atom, such as, for example, methyl, ethyl, propyl, isopropyl, butyl, isobutyl, neobutyl, pentyl, isopentyl, neopentyl, hexyl, isohexyl, neohexyl, cyclohexyl, heptyl, octyl, nonyl, decyl, 2-methylbutyl, 3-methylbutyl, 2-methylpentyl, 3-methylpentyl, 4-methylpentyl, 2,3-dimethylbutyl, 2-ethylhexyl, 3-methylhexyl, 4-methylhexyl, 5-methylhexyl, 2,4-dimethylpentyl, 2-methyl-5-butylhexyl, 2,5-dimethylhexyl, 6-methylheptyl, 2-methylheptyl, 2,2-dimethylheptyl, 4-methylheptyl, 5-methylheptyl, 3,5-dimethylheptyl, 2,5-dimethylheptyl, 2,4-dimethylheptyl.

This spirooxazines dye is dissolved in an organic solvent such as, for example, toluene, xylene, methanol or ethanol, and irradiated with ultraviolet light at 365 nm, the solution can absorb light with a wavelength between 540 and 600 nm.

For better understanding the above-mentioned and other objects, features and advantages of the invention, the following examples are provided and used to illustrate the invention more detained in conjunction with the accompanied drawings.

The photochromic functional colorant, spirooxarines, of a structure shown in FIG. 7, according to the invention can be synthesized by the following steps:

1. The Synthesis of Fisher Base (c):

As illustrated in the synthetic scheme shown in FIG. 8, 20.9 g (0.100 mol) of 2,3,3-trimethyl-4,5-benzo-3H-indole, 17.0 g (0.120 mol) of methyl iodide and 200 ml of ethyl acetate were charged in a 500-ml rounded bottom flask and the resulting reaction mixture was heated at 50° C. with stirring for 4 hours. At the end of the reaction, the reaction flask was cooled to 0° C., filtered off organic salts through a filtering funnel (step (b)), and the solid on the funnel was washed with a small amount of ethyl acetate. The thus obtained solid organic salts was basified directly with 3 N sodium hydroxide solution and then extracted several times with ethyl acetate. The combined extracts were concentrated under reduced pressure to remove ethyl acetate to obtain 18.9 g (yield: 84.8%) of Fischer base (c) product.

2. Synthesis of Spirooxarines (e) Dye

According to the reaction scheme illustrated in FIG. 9, Fischer base (3.0 g, 13.43 mmol) was weighed in a reaction flask. Then, piperidine (2.06 g, 24.17 mmol) and 15 ml ethyl acetate were added and the resulting mixture was heated at 66° C. with stirring for 30 minutes. Thereafter, 1-nitroso-2-naphthol (3.02 g, 17.46 mmol) was added thereto and the reaction was continued for 6 hours. At the end of the reaction, the reaction mixture was cooled to room temperature, and extracted with 3 N HCl aqueous solution. The organic layer was washed with saturated aqueous sodium bicarbonate solution, and saturated brine. The extraction procedure was repeated twice, and then the organic phase was dried over anhydrous sodium carbonate, filtered and concentrated under reduced pressure. The residue was purified with silica gel column chromatography (CH₂Cl₂/n-Hexane) to obtain 3.12 g (yield: 50.3%) of the desired spirooxarines (e) product. NMR:

The change of the thus synthesized spirooxazines in a solvent upon UV irradiation was investigated as follow. The compound was formulated at a concentration of 20 ppm in ethanol and the UV/VIS spectrum of this solution was recorded with reference to ethanol as the standard before UV irradiation. Its maximum absorption was observed at 357 nm. After irradiating under a UV lamp (6 W, 365 nm) for 30 seconds, the UV/VIS absorption spectrum of the same solution was recorded with reference to the original non-irradiated solution, and observed a maximum absorption band at 578 nm.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A photochromic dye of following structure: 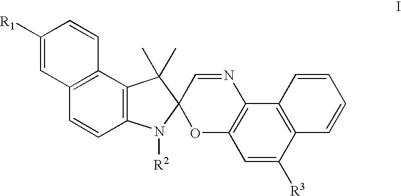
wherein R1 and R2 is selected independently from a group consisting of a linear or branched alkyl having 1 to 20 carbon atoms, a linear or branched alkenyl having 2 to 20 carbon atoms, a linear or branched alkynyl having 2 to 20 carbon atoms, a linear or branched alkoxy having 1 to 20 carbon atoms, a haloalkyl, a haloalkenyl, and halogen- or hydrogen-containing function groups; R3 is a secondary amino group; characterized in that it can be used as a photochromic dye by formulating with suitable organic solvents and exciting with ultraviolet light.

2. A photochromic dye as in claim 1, wherein the nitrogen atom of the secondary amino group R3 is attached with a linear, cyclic or branched functional group containing 1 to 10 carbon atoms.

3. A photochromic dye as in claim 1, wherein R1 and R2 may be the same or different, and is selected independently from the group consisting of a linear or branched alkyl having 1 to 20 carbon atoms, a linear or branched alkenyl having 2 to 20 carbon atoms, a linear or branched alkynyl having 2 to 20 carbon atoms, a linear or branched alkoxy having 1 to 20 carbon atoms, a haloalkyl, a haloalkenyl, and halogen- or hydrogen-containing function groups.

4. A photochromic dye as in claim 1 for applying on an optical memory.
